(19) United States
(12) Patent Application Publication
(10) Pub. No.: US 2017/0195483 A1
(43) Pub. Date: Jul. 6, 2017

(54) COMMUNICATION SYSTEM WITH SERVICE SELECTION BY DIALLING

(71) Applicant: SATCOM1 APS, Greve (DK)

(72) Inventor: Jean-Francois GAULT, Margency (FR)

(73) Assignee: HONEYWELL INTERNATIONAL INC., Morris Plains, NJ (US)

(21) Appl. No.: 15/305,064

(22) PCT Filed: Apr. 21, 2015
(86) PCT No.: PCT/EP2015/058548

§ 371 Date: Oct. 18, 2016

(30) Foreign Application Priority Data
Apr. 24, 2014 (FR) 1453682

(51) Int. Cl. H04M 3/42; H04M 7/00

(52) U.S. Cl. CPC H04M 3/42289; H04M 7/0066; H04M 2207/185; H04M 2203/2011; H04M 2203/609; H04L 63/0272

(57) ABSTRACT

A communication system includes a means for dialling a complex call number that is a concatenation of a service code that identifies a specific service and a called number selected by a calling party. The system further includes processing means for carrying out at least one service identified by the service code over at least a part of a communication path between a calling party and a called party, and means for decoding the service code inserted in the complex call number during the ongoing call and to apply the selected service using the processing means. The service code is indicated or invoked by entering the number of the called party between at least two “*” characters and/or at least two “#” characters.

### CROSS-REFERENCE TO RELATED APPLICATION

This application is a U.S. National-Stage entry under 35 U.S. C. §371 based on International Application No. PCT/EP2015/058548, filed Apr. 21, 2015, which claims priority to French German Application No. 1453682, filed Apr. 24, 2014, which are all hereby incorporated in their entirety by reference.

### TECHNICAL FIELD

The present invention relates to a communication system with service selection by dialling.

### BACKGROUND

In the prior art, there are telephone terminals which have means for generating a called number. The telephone terminal comprises a resource for generating a calling signal which contains in particular the called number in order to reach a correspondent equipped with a telephone terminal and answering said called number.

It is also known that some fields of the called number can receive information that render the call distinctive, such as the code of the country in which the called party is located. On the communication network, the transmission channels are then selected by a resource that decodes the called number field containing the country code of the called party to connect to an access gateway to a national network or similar.

In the avionics environment, e.g., in the cabin of an airliner or other aircraft, there are a number of situations in which the quality of service associated with the transmission of the message exchanged between a correspondent in the aircraft cabin and another correspondent, on the ground, for example, is determined by the nature of the communication or because the correspondents demand a given level of service quality.

Outside the field of avionics, the selection of service quality services is described for example in EP-A-1111859. But entering a code when dialling is then a complex operation.

By way of a non-limiting example, in the avionics industry service quality may include compliance with various communication or transmission characteristics such as data rate, non-interruption of communication, communication noise, security of data exchanged in communication by the provider of access to the communication network between the calling party and the called party, or the subscription of the calling party to a particular service providing a defined service quality.

For example, the calling party may want the communication to be sent at a rate and failure rate determined by data packets in a data packet communication network, or that its data be encrypted on all or part of communication path to prevent it from being usable by unauthorised entities on the communication route or path.

The fact of providing such service quality by the provider of access to communication resources is subject to variable costs which must be adapted according to a number of constraints, associated particularly with routing that data packets that make up the communication.

A subscriber's subscription to a service and selection for making a particular call are difficult operations that require particular attention by the calling party and oblige the access provider to open special processing means to handle such requests and then deliver the communication initiated by the calling party according to the contract signed.

GB-A-2.293.719 also describes a communication data encryption service. The complexity of the method requires use of a separate signal channel. Signalisation of an encrypted call requires manual input of an encryption request code and a request code for use of a special access channel to a dedicated encryption gateway.

Document EP-A-1.434.446 describes the use of an identification code which must be decoded using an identification code table and the identification code used must be converted when the ongoing call leaves the private network to enter the public network. Such a solution is not feasible in the field of communications between onboard communication resources on a mobile platform such as an aircraft and ground communication resources.

The problems cited in the preceding text become even more difficult to solve when the calling terminal and/or the called terminal is located in an area of limited radio frequency emissions such as aircraft cabin. In this case, the problem is rendered still more complex by the fact that the mobile telephony network, GSM type for example, is not available in particular for long periods of the flight, mainly because the aircraft is not in a coverage area of the mobile telephony network.

### BRIEF SUMMARY

It is an object of the present disclosure to suggest an advantageous technical solution that allows the calling party to make a call to a called number by selecting the service type with which the network communication access provider is to handle the call. The inventive system is of the type in which the calling party has a terminal connected by a specified link to the communication resources of a communication access provider that are capable of transmitting the communication data to at least one called party designated by the calling party using a telephone number.

As is known, a communication system of such kind includes:
A resource for dialling a complex called number, particularly by concatenation, based on a service code that identifies a specific service and on a called number selected by a calling party;
A processing resource for carrying out at least one service identified by said service code over at least a part of the communication path between the calling party and the called party;
Means provided by the access provider to decode the service code entered in the complex called number during the ongoing call and to apply the selected service using said processing resource.

According to one embodiment, the service code is indicated or invoked by entering the number of the called party between at least two “*” characters and/or at least two “#” characters.

According to other characteristics:
The communication system further comprises a resource allocation of said service code for inclusion in the complex number called depending on the selection by the calling party of a single, specific communication service from services pertaining to delivery of a specific service quality for at least one communication parameter selected in particular from the data rate, the communication packet size, data encryption over a given communication path;
The processing resource of at least one service identified by said service code comprises:
Means for determining communication paths; and/or
Encryption means; and/or
Means for creating at least one tunnel, particularly of the VPN type, on at least part of the communication path;
The processing resource for at least one service identified by said service code includes at least one router connected to the calling terminal and possibly to the called terminal via links such as a local network, particularly of the WiFi type, wherein the terminal is equipped with a modem capable of connecting to the router, particularly of the WiFi type;
The router has at least one access to a satellite network, particularly of the INMARSAT (Registered Trademark)/BGAN type;
The calling terminal and/or the called terminal are mobile phones, particularly implementing the UMA/GAN, 2G/3G/4G/5G, IMS, and/or SIP standards, and/or that the router comprises a GAN (Generic Access Network) system;
The system includes a resource for incorporating the dialling service in said resource for allocating a service code for insertion in the called number depending on the subscriber's choice of service quality specified from a list of communication service options, including a software application loader and/or a pre-loaded SIM card and a means for subscribing to the dialling service;
The processing resource of at least one service identified by said service code includes means for decoding the service code (CS) inserted in the called number so as to activate the means for selecting routing rules and/or encryption rules and/or establishing at least one tunnel for ordering communication by at least one modem in a specified communications network;
The unique service system is a service for ensuring communication security between a calling party and a called party, in particular by encrypting communication data, wherein the calling terminal comprises a resource for generating a complex number consisting of the number of the called party framed by two “*” characters or two “#” characters and at least some of the communication on the communication path comprises a means for decoding the complex number and receiving the communication from the calling party to the called party and determining that a communication data encryption service is in use for the ongoing call, wherein said decoding means invokes communication data encryption means for the communication path as far as the following communication segment or the destination terminal by means of a control signal;
The system further includes a resource for testing the progress of the call to the called party and if necessary to generate an alert message for sending to the calling party from the called party and/or the communication access provider in the event of failure of the communication corresponding to the service quality specified by the service quality selection code chosen by the calling party and/or to notify a party, for example the called party, that the current call progression is produced as an encryption communication by a service quality management service;
The system further comprises a resource inserted in the communication path during the progress of the call to the calling party for the purpose of applying the service specified by the service management code entered in the called number;
The system includes at least one resource for issuing a destination notification for at least one communication addressee party, including the calling and the called parties to notify the addressee party that the current call is a call subject to a service quality management service, particularly such as communication security by encryption of communication data, or that it is an attempt to make a call that is secure, or more generally subject to service quality management, in particular by voice or encrypted text-type messages, in particular:
The system is used:
by at least one human user using a telephone terminal as a mobile phone;
by a telephony network, at least some of which may comprise a satellite link;
by a robot or machine such as a drone, aircraft, land, sea or space vehicle;
by subscription to a communications service for selecting the service quality;
in the cabin of an aircraft or other land, sea or space vehicle.

### BRIEF DESCRIPTION OF THE DRAWINGS

Other features and advantages of the present invention will become apparent from reading the description with reference to the accompanying drawing, of which:

FIG. 1 shows a diagram of an example of dialling with service code integration;

FIG. 2 shows a communications diagram in an avionics environment;

FIG. 3 shows a particular embodiment of an avionics communication system incorporating the invention; and

FIG. 4 shows an implementation of the invention over a part of the communication path.

### DETAILED DESCRIPTION

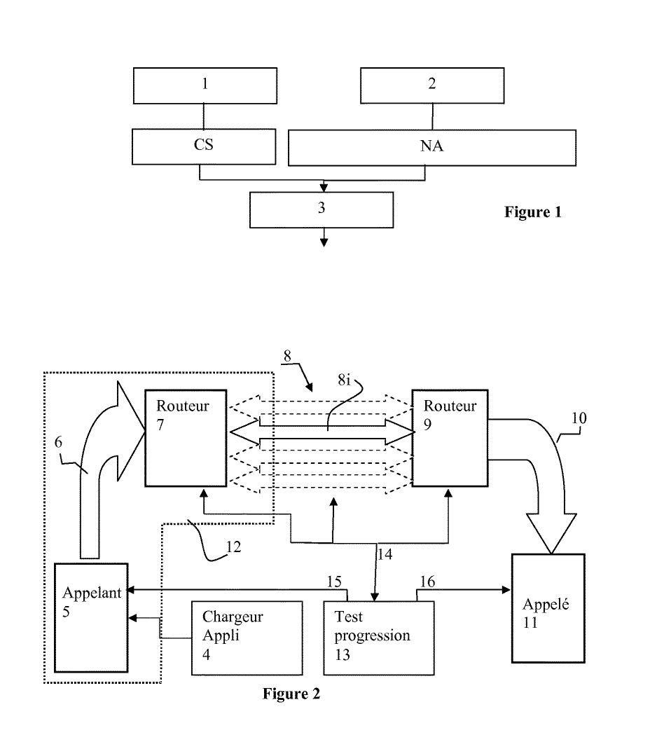

In FIG. 1, the diagram shows a diagram of one embodiment of a dialling system for integration in services which will be used to explain what is defined in the state of the art and finally how to arrive at the invention.

It has previously been suggested that the phone number of the called party is a complex number, then consisting of a first word (CS) identifying the code of the service selected by the calling party, and a second word (NA) comprising the telephone number of the called party. In one embodiment, the second word (NA) is selected by the calling party on his mobile phone from the address book. The first word (CS) is automatically added as a prefix by a software application running on the calling party's mobile phone. The software application is downloaded to the mobile phone in the normal way when the calling party subscribes to a service that can be activated with a service code (CS).

In one embodiment, the first word (CS) is selected in a specific sequence of service codes, such as the following partial list containing some examples of services with their corresponding CS code:

01# low-speed voice

02# high-speed data

03# increased data packet size

. . .

10# encryption on the land part of the routing

20# encryption on the satellite part of the routing

Thus, if the subscriber and calling party wishes to have a service with larger data packet size (CS code=03#), a resource for allocating a CS service code for insertion in the called number depending on the subscriber's choice of a specific service quality assigns the code selected by the subscriber as CS=03#.

In one example of the prior art, the first word (CS) is based on the aforementioned list of service codes and at least some of them can be combined to limit the number of digits of the CS code.

If the list of available codes is modified appropriately, it is possible for the subscriber to designate a combination of services to the communication service operator to which he has subscribed.

Thus, if the subscriber wishes to obtain both a service with larger data packet size (CS=code 03#) and encryption of the satellite part of the routing (CS=code 20#), a resource for allocating a service code (CS) to be included in the dialled number based on the subscriber's choice of a specific service quality allocates a combination such as CS=23#, obtained here by adding the digits of the CS codes of the two services selected at the same time by the user.

In another example, shown in FIG. 1, resource 1 for allocating a CS service code for inclusion in the dialled number based on the subscriber's choice of a specific service quality, is connected to dialling resource 3 and to a resource 2 for selecting a called number.

Resource 2 for selecting a called number may include a keypad for entering the called number, and/or a database for selecting a correspondent from a list of matching correspondents and extracting the number to be called from the database. Such a database is often called the address book, and it is stored in the memory of the calling terminal.

In another example, the three resources 1-3 described by FIG. 1 are combined in a mobile phone, of the GSM type for example but not limited thereto. More specifically, these resources are at least partly configured in the mobile phone with the aid of a software application downloaded from a dedicated server upon subscription to at least one service identified by the CS service code supplied and then executed by the communication access provider.

This software application is loaded in the program memory of the mobile phone and, when the subscriber wishes to engage in a communication involving at least one communication service selected by the CS service code, he executes said software application.

In another embodiment, the software application, and depending on the circumstances some or all of the resources 1-3 described by FIG. 1, are provided on a SIM card. A SIM card (Subscriber Identity Module) has a chip containing a microcontroller and memory. It is used to store data specific to the subscriber to a mobile network, particularly GSM, UMTS and LTE type networks. It can also store data and applications belonging to the user, the operator or third parties. Other mobile telephony systems such as CDMA One, PDC or CDMA 2000 defined by 3GPP also allow use of such a card.

The SIM card contains the subscriber identifier (IMSI no.) and the identifier of the mobile operator who issued the card (MCC+MNC). It is thus provided that the access provider to a mobile phone network in the broad sense, will issue a new SIM card particularly containing the list of internal service codes for resource 1 for allocating a CS service code for insertion. For example, a single CS service code will be included in the subscription upon subscription so that the user interface is simplified drastically when dialling. Of course, in other embodiments, resource 1 for allocating a CS service code for insertion in the called number based on the subscriber's choice of a specific service quality comprises a list of CS codes as described above and an interface that allows the subscriber to choose the desired service quality.

In other examples of the prior art, the SIM card contains at least a part of the three numbering resource and the resource to select a called number 2.

In other examples of the prior art, the SIM card contains at least a part of the dialling resource 3 and of the resource 2 for selecting a called number.

When a call is ordered by the subscriber on a mobile phone equipped with a SIM card as described above or a software application downloaded as was also described previously, the communication system concatenates the service code (CS) and the called number (NA) to generate the concatenated complex number on the telephone communication network.

In another example of the prior art, if the service code (CS) chosen or selected is “23#” in prefix mode, and the called number (NA) is “01234567”, the complex number issued at the output of resource 3 will be “23#01234567”, the concatenation operation being performed by dialling resource 3.

Of course, other concatenations are possible, particularly in postfix mode, such as “01234567#23”, in which the CS code was started with a “#” separator. Other separators, or no separator, can also be programmed depending on the dialling characteristics of the communication networks used.

Unlike the prior art, the communication service provided by the invention using a service code (CS) comprises a single service such as a communication encryption service for the calling party as far as the called device. In this case, the service code can be reduced to its simplest expression, such as the presence of a single character “#” before or after the called number when it is dialled by the calling party on his own communication terminal.

When the call progresses from the calling party to the called party, the communication data, which may be voice, data, SMS standard short messages, MMS standard composite messages, G3 standard faxes, for example, or even video calls are encrypted by an encryption resource serving as a means to apply the communication service selected on the basis of the CS code, and using a processing resource of at least one service identified by said service code over at least part of the communication path between the calling and called parties, wherein said processing resource or performance of the service selected using the CS service code will be defined later.

According to one aspect of the invention, the communication system offers the calling party a single service for rendering its communication secure, achieved mainly by encrypting communication data.

The single quality service management service offered here is thus specified or invoked by entering the number of the called party between at least two ‘*’ characters and/or between at least two ‘#’ characters. In one embodiment, the single service is an encryption service.

For example, in order to call the subscriber whose telephone number is “0123456789” a string of ten digits, when the calling party dials this number for the called subscriber and has selected the communication data encryption service of, the dialling resource on the calling terminal according to the invention generates the following complex number: *0123456789*.

The complex number *0123456789* is then routed along the communication path or route. It is first decoded by any party in the communication path so that the presence of two ‘*’ characters before and after the numeric string is interpreted by the decoding party as the command for encrypted communication. If the next segment of the path is under the control of the decoding party, this party then generates an encryption of the communication data associated with the complex number *01234556789* and forwards the data packets corresponding to the communication towards the called party in encrypted form in known manner.

The number of characters surrounding the called number can be freely selected within the scope of the invention, for example for selecting different service qualities or encryption levels according to the number of “*” characters placed to the right and left of the called number. The same can be done with the numbers surrounded by the “#” character or combinations of the “*” and “#” characters.

It should be noted that the telephone standards already know the composition of prefixes such as the call forwarding service. Such a service enables a given terminal to direct incoming calls to another number if the number of the given terminal is busy or does not answer when called. Thus, a subscriber with terminal having a dialled number consisting of digit string X1 who activates the complex number *21*X2# is requesting that calls to the called number X1 be redirected to the terminal with a called number consisting of registered digit string X2. This command can be cancelled by the subscriber on the terminal with call number X1 by dialling code ##21#.

The mechanism according to the invention is very different, whether as a prefix code, a suffix code or a combination of the two, or also in that the service code is reduced to a ‘*’ or ‘#’ character. In fact, it is the number of the called party that the calling party links with the service code, not another phone number as in a call forwarding service.

To distinguish the service quality management service code, such as communication encryption, from a standard service code such as call forwarding, the resources of the invention use a decoding means which, upon detecting the complex number “*01234567789*” first detect the first “*” character. This first “*” character may indicate a standard telephone service code such as call forwarding. But then the decoding means counts the number of digits that follow the first “*” character. Since this number of numeric characters, limited by the second “*” character has a length at least equal to that of a called number, and not equal to the standard length of two numeric characters of normal or standard telephone service codes, the decoding means then produces the following two items of information for the party on the communication path that cooperates with the complex number decoding means:

1) information indicating that the complex number requires encryption of the communication data during the current communication between the calling party and the called terminal designated by telephone number “0123456789”;

2) the actual number called: “0123456789”.

The party on the communication path that cooperates with the complex number decoding means then negotiates the subsequent communication path to the called party with another communication element for the called party itself, encryption of communication data is then performed in known manner by each communication element.

It should be noted that the number of the called party may or may not also include a country code, which may or may not be separated from the national number of the called party by a separator such as “00” or by one or more characters such as “*” or “#”.

In one embodiment, the calling party selects the called number in the address book, stored in the terminal or on the SIM card, and launches the communication security application.

This application then generates the complex number *0123456789* based on the number 0123456789 selected by the calling party from his address book. The complex number is then transmitted via the communication network to the first communication element, such as a router 7 in the case of the embodiment of FIG. 2, wherein router 7 is part of the resource for processing the service selected using the service code (CS) included in the complex number of the call in progress on the communication path.

Router 7 or the first communication element equipped with the means for decoding the complex number described above, then applies an encryption to all communication data using a suitable encryption means, known in the prior art. All other communication parties such as the last communicating party 9 or the router of the called terminal then carry out the necessary encryptions and decryptions based on the information generated by their own means for decoding the complex number on the communication path.

Thus, in some embodiments, the complex number according to the invention may have the following forms:
Form 1: *+<international prefix><national number>*,
Form 2: *00<international prefix><national number>*,
Form 3: *<national prefix><national number>*, in which:
Form 1 uses the frame between two “*” characters, but the first “*” character is followed by the ‘+’ character, indicating that the subsequent characters identify the international prefix in the character string denoted by <international prefix>, then the number of the called party, which is a national telephone number denoted by <national number>;
Form 2 is the same as form 1 but in this case the character “+” is replaced with two digits ‘0’, that is to say ‘00’; and
Form 3 is the same as forms 1 and 2 except that the characters ‘+’ or ‘00’ are omitted.

FIG. 4 represents the implementation of the invention on a part of the communication path. The communication system of this embodiment provides a single communication security service between a calling party and a called party. Ensuring security is a service of service quality management which is guaranteed chiefly by encrypting the communication data. Calling terminal 5 has a resource 7; 4 for generating a complex number as described earlier, including the telephone number of the called party surrounded by two characters “*” or “#”, said enclosure serving as a service code (CS) within the meaning o of the invention.

At least one communication element 40 on the communication path comprises a means 41 for decoding the complex number for receiving communication from the calling party 5 to called party 11 as incoming communication path 45.

Decoding means 41 is equipped with the means described above for determining that it is a communication data encryption service for the current call that requests—via a command signal 47—encryption means 42 for the outgoing communication path 46 from communication element 40 to the next communication element 44 or the called terminal 11.

Communication element 40 may be repeated several times on the communication path depending on the overall communication path computed by the communication system. It may exist only on router 7 if the communication path is in a single segment 8 (example shown in FIG. 2). Of course, receiving router 9 or called terminal 11 (FIG. 2) may be the last communication element, in which case they need a means for decrypting the encrypted communication.

To describe the mode in which the call progresses in general, we will now describe a particular embodiment of the system according to the invention shown in FIG. 2.

Referring again to FIG. 2, the communication system with dialling service selection mainly comprises a mobile phone 5 connected to a router 7 by a first link 6. Router 7 is connected by a plurality of paths that can be selected according to predetermined routing rules which are known. A second router 9 can be accessed by at least one of the paths of the plurality of selectable paths 8 and is connected by another link 10 to at least another called telephone 11, mobile-type or otherwise. In particular, the called telephone can be connected directly to a communication network such as a terrestrial telephony network and second router 9 is then replaced by a telephone exchange of known type.

In one embodiment, first link 6, and optionally second link 10 is/are a wireless connection type which connects the calling telephone 5 to the called telephone 11.

We will now describe a resource 4 for integrating the dialling service in the said resource for allocating a service code to be inserted in the called number. This CS code will be selected based on the subscriber's choice of service quality from a list of optional communication services. The integration resource 4 may comprise a resource for loading software applications and/or a preloaded SIM card or also a means for subscribing to the dialling service.

The communication system with service selection by dialling thus comprises a resource 4 for loading a software application that enables telephone 5, and optionally called telephone 11 to be loaded with at least a part of resources 1-3 described with FIG. 1 such that the system of the invention includes resource 1 for allocating a service code (CS) for inclusion in the dialled number based on the subscriber's choice of a specified service quality, dialling resource 3 and resource 2 for selecting a number for calling. As explained earlier, the calling subscriber chooses the desired service quality by selecting the service code (CS) for the service quality management service and the called number and the call is initiated by the issuance of the combined number consisting of the concatenation of the CS code and the called number.

First router 7 via first connection 6 receives the combined number and decodes it so that it then recognises the CS code of the service quality management service and the number of the called party (NA).

First router 7 uses the CS code to determine the paths such as path 8i which serve to ensure the service quality selected by the calling party when placing the call and the flow of data from calling phone 5 may then be processed by first router 7.

Specifically, first router 7 contains a number of communication resources such as access to a satellite communications network, for example INMARSAT, INMARSAT/BGAN, and it may also determine routing rules on other communications networks accessing the satellite communication network as INMARSAT/BGAN, such as a landline telephony network, one or more terrestrial telephony networks such as GSM, the Internet data network, etc. The first router 7 then applies routing rules to assure the service quality requested according to the CS code.

In a particular embodiment of the invention, the first router 7 is provided in known manner with means for detecting whether called party 11 is able to processing the call from calling party 5. In particular, depending on the service selected with the CS code for the service quality management service of the current call, the calling party or an element on selected path 8i is unable to operate the call.

First router 7, or the system of the invention if central management is provided, cooperates with a resource 13 for testing the progress of the call. An error may be detected by means of sensors 14 connected to communication paths 8, but also on first router 7 and second router 9 or any other equipment designed to establish a connection with called party 11. In one embodiment, connected probes 14 consist of software routines that detect internal error messages from the various communication networks or communication equipment and retransmit them according to predetermined rules.

When an error is detected in this way, resource 13 for testing the call progress generates an error message that is transmitted initially to the calling party 5 via a link 15 or to the called party 11 via a link 16. The error message output by resource 13 may include identification of the cause of the error and/or simply report that called party 11 cannot be reached.

In one embodiment, the called party 11 who cannot be reached with the service quality invoked with the CS code entered by calling party 5 may, however, receive a message, relayed by its own telecommunication operator for example. The unreachable called party 11 may also receive a message output by the access provider which manages the communication system with service selection by dialling of the invention, particularly including the offer for subscribing to the receive a message output by the access provider which manages the communication system with service selection by dialling of the invention.

In another embodiment, resource 13 for testing call progress also includes means for notifying a communication party such as the calling or the called party that the call in progress is generated by a quality service management service such as communication encryption.

When an attempt to make a secure call or more generally to manage the service quality is conducted from a called terminal, it is often necessary for the called terminal, and often several intermediate communication elements to be equipped with special resources that not only enable them to receive the call but also allow the call to take place.

This is particularly the case when the call is a secure call by voice or particularly by encrypted text messages. If the called terminal is not equipped with a decrypting means or if an intermediate element does not allow the progression of an encrypted call to be processed, it is expedient for the various communication elements, including the calling party and/or the called party to be notified of the situation. Notification of this situation to the called party which is not equipped with a decryption resource enables the party to call the correspondent back and make his aware of the situation or to contact an access provider to the telephone network which is in a position to send the necessary resources. Notification to the calling party is also useful, to provide warning that the called party was unable to process the call.

In particular, a favourable situation is created when the provider of access to the telephone network keeps a record in a subscriber database of the users equipped with telephone numbers and who are equipped with resources for dialling a complex number for service quality management and other resources that are necessary for implementation of the invention and are described herein.

When the call is generated, the provider can decide whether the called number corresponds to a subscriber to the desired service quality management service, for example security by encrypting communications. It can then deduce a state of alert or notification to the various elements, and to the calling party and/or the called party as described above.

In the example described with reference to FIG. 2, the communication system for selecting the service by dialling comprises at least one calling terminal, such as mobile phone 5, which is in a controlled access zone 12 such as the cabin of an aircraft. In this case, a mobile telephony network is not always available.

The use of a LAN as the first link 6 and a first router 7 with connection to different communication networks, including one or more satellite networks, enables a voice or data call to be routed to other networks including a mobile telephony or fixed telephone network so that it is possible to make calls from a mobile telephone to any network while using the communication services of the system of the invention, each making it possible to obtain specified service quality for at least one communication parameter including data rate, communication packet size, data encryption on a given communication path.

In the encryption measures, a special parameter for setting the service quality or a service for changing the service quality enabled by the CS code dialling option, is provided to create or establish one or more VPN tunnels or the like on some or all of the communication path. The creation of a tunnel returns to use of the Internet or another communication network, such as a satellite communication network, as a transmission medium using a “tunnelling” protocol, that is to say encapsulating data to be transmitted in encrypted form. This is called VPN to designate the artificial network thus created. This network is called virtual because it links two “physical” networks (LANs set up on the calling terminal and the called terminal) via a non-trusted link (such as the Internet communication network), and private because only the network computers on either side of the VPN can access the plaintext data.

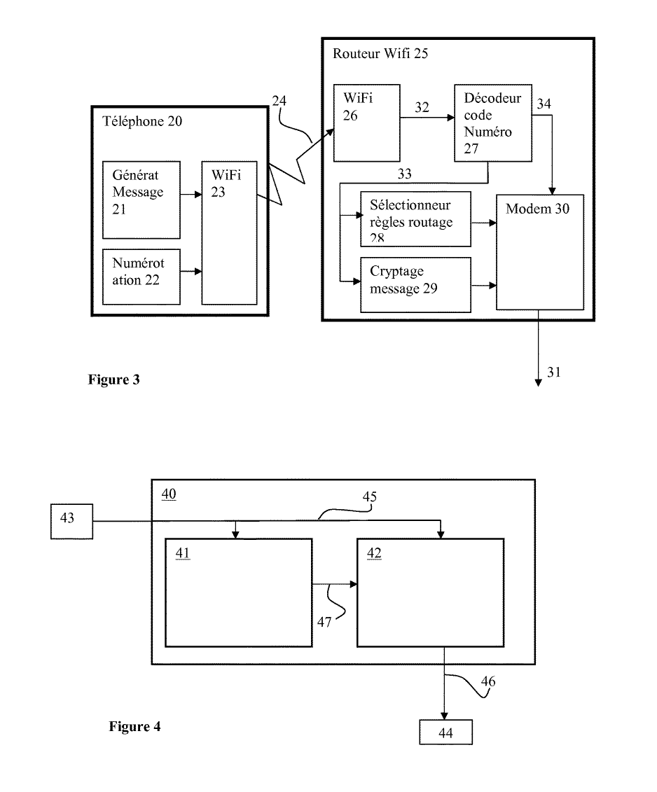

FIG. 3 illustrates another embodiment of the calling party of the communication system with service selection by dialling according to the invention.

The first communication element comprises calling terminal 20, consisting of a mobile phone 20 equipped with a WiFi radio frequency wireless communication resource 23 to integrate with a local WiFi network 24. Mobile phone 20 functions as the calling party 5 of FIG. 2, while the wireless LAN 24 serves as the first link 6 of FIG. 2.

An avionics WiFi router 25 is also connected to the local WiFi network 24 via its own WiFi modem 26. Avionics WiFi router 25 further includes at least one modem 30, preferably over a satellite communications network, e.g., of type INMARSAT/BGAN 31. Avionics WiFi router 25 can be a SATCOM 1™ brand AvioIP type router of public documentation, to which reference is herewith made. It functions as first router 7 of the inventive system shown in FIG. 2.

The mobile phone 20 with WiFi modem 23 comprises a message generator circuit 21 which may particularly include a microphone—loudspeaker assembly for voice communication and a keyboard—monitor assembly for data communication, with the associated software applications. Mobile phone 20 then comprises the resource for dialling with insertion of the CS code for the service quality management service with integrates at least part of the resources 1-3 described with FIG. 1, and the use of which is described with the system of FIG. 2.

Communication initiated on the local WiFi network 24, is received by WiFi modem 26 of router 25. The data 32 issued by WiFi mobile phone 20 is then decoded by a resource 27 for decoding CS codes for service quality selection. In the dialling sequence, resource 27 then separates the CS code from the rest of the data 32 to send it 33 on a resource for selecting routing rules based on the CS code transmitted 33 when it was input.

The routing rules determined by the CS code are then applied in known manner to modem 30, while the rest of the data 34 from decoder 27 is forwarded to data input 34 of modem 30.

In one embodiment, when the CS code includes selection of a data encryption service, output 33 of decoder activates a resource 29 for communication encryption initiated by mobile phone 20.

Modem 30 is connected to at least one communication network 31, such as a satellite communication network INMARSAT/BGAN, so that the routing rules selected by resource 28 for selecting routing rules can be applied to the data entering communications network 31 and to other possible communications networks to which it is connected by bridges, in known manner to generate the plurality of paths 8 described in FIG. 2.

In other embodiments, the calling party and/or the called party are not mobile phones but terminals such as computers, or control PLCs. Such terminals are fitted in automatic equipment such as drones or non-automated airborne, space, waterborne or land vehicles or also amphibious machines.

Specifically, several components necessary to achieve the main resources of the inventive system are available in one or more communication standards including UMA/GAN, 2G/3G/4G/5G, IMS and/or SIP.

In one embodiment, router 7, 9 comprises a GAN (Generic Access Network) system. In such a GAN system, the calling terminal is coupled with a module incorporating the local GAN system via a WiFi connection or the like. This then functions as a base transmission station (BTS) to connect to the global network or WAN through which the call will progress to the called terminal. It is then the GAN system which is programmed to implement the service quality management service. In particular, an encryption service is then for example offered to the subscriber who is using a calling terminal equipped with a resource for selection the service quality management service and for applying encryption—or other service quality management service—to the “clear text” part of the call progression as far as the called party.

Preferably, when router 7 or 9 cooperates with or is constituted by a GAN system, the calling terminal and/or called terminal is a UMA compatible device or the like. In the connection between the phone and the GAN system, a first encrypted tunnel is implemented natively. To implement the invention, the UMA phone must therefore be equipped with a software application for generating the complex number that invokes secure communication. When the complex number is generated by the native dialling resource, the VPN tunnel with the GAN system is initiated and communication begins with a path secured by encryption in known manner. As the call progresses, especially between the GAN system and the subsequent path, an encryption resource is in turn activated to continue the secure communication according to the teaching of the invention and so forth until it reaches the called party.

As has been described above, the invention can be implemented in all kinds of communication networks, since, for example, encrypting means can be activated by a complex number of the decoding means formed by the invention, at any communication element on the communication path between the calling party and the called party.

The same applies when the complex dialling applied according to the teaching of the invention invokes a specific management service of the service quality from the calling terminal.

In the embodiment which has just been described, the communication system includes a resource inserted in the communication path during the progression of the call to the calling party so as to apply the service specified by the service management code inserted in the called number.

The first link 6 and/or the second link 10 have been described with the WiFi standard. Other connections are possible, including optical fibres, and can implement VPN tunnels to improve data security.

1-13. (canceled)

14. A communication system with service selection by dialling, in which at least a calling terminal is connected by a specified link to communication resources of a communication access provider, the communication resources capable of transmitting communication data to at least one called party designated by a calling party by means of a telephone number, the communication system comprising:
means for dialling a complex call number, the complex call number being a concatenation of a service code that identifies a specific service and a called number selected by a calling party;
processing means for carrying out at least one service identified by said service code over at least a part of a communication path between the calling party and the called party; and
means for decoding the service code inserted in the complex call number during the ongoing call and to apply the selected service using said processing means,
wherein the service code is indicated or invoked by entering the number of the called party between at least two “*” characters and/or at least two “#” characters.

15. The system according to claim 14, further comprising:
means for allocating said service code (CS) for inclusion in the complex call number depending on a selection by the calling party of a single, specific communication service from services pertaining to delivery of a specific service quality for at least one communication parameter selected from data rate, data packet size, and data encryption over a given communication path.

16. The system according to claim 14, wherein the processing means comprises one or more of:
means for determining communication paths;
encryption means; and
means for creating at least one tunnel of the VPN type on at least part of the communication path.

17. The system according to claim 16, wherein the processing means further comprises:
at least one router connected to the calling party and possibly to a called terminal via a local network; and
a modem capable of connecting to the router.

18. The system according to claim 17, wherein the router has at least one access to a satellite network.

19. The system according to claim 17, wherein:
one or both of the calling terminal and the called terminal comprise a mobile phone; and
the router comprises a GAN (Generic Access Network) system.

20. The system of claim 14, further comprising:
means for allocating a service code for insertion in the called number depending on a subscriber's choice of service quality specified from a list of communication service options,
wherein said means for allocating comprises:
one or more of a software application loader and a pre-loaded SIM card, and
means for subscribing to the dialling service.

21. The system according to claim 20, further comprising:
means for decoding the service code inserted in the called number;
means, responsive to the decoded service code, for selecting routing rules; and
means, responsive to the decoded service code, for implementing encryption rules.

22. The system according to claim 21, further comprising:
means for generating a complex number consisting of the number of the called party framed by two “*” characters or two “#” characters; and
means for decoding the complex number and receiving (45) the communication from the calling party and determining that a communication data encryption service is in use for the ongoing call.

23. The system according to claim 14, further comprising:
means for testing call progression and selectively generating an alert message.

24. The system according of claim 14, further comprising means, inserted in the communication path, for applying the specific service identified by the service code.

25. The system according to claim 14, further comprising:
means for issuing a destination notification for at least one communication addressee party, to thereby notify the addressee party that the current call is a call subject to a service quality management service.

26. The system according to claim 14, wherein the system is configured to be used:
by at least one human user using a telephone terminal as a mobile phone;
by a telephony network, at least some of which may comprise a satellite link;
by a robot or machine such as a drone, aircraft, land, sea or space vehicle;
by subscription to a communications service for selecting the service quality;
in a cabin of an aircraft or other land, sea or space vehicle.
